(19) United States
(12) Patent Application Publication
(10) Pub. No.: US 2026/0216948 A1
(43) Pub. Date: Jul. 30, 2026

(54) METHOD FOR PRODUCING A FUNCTIONAL ELEMENT WITH SURFACE STRUCTURES, AND FUNCTIONAL ELEMENT

(71) Applicant: Fraunhofer-Gesellschaft zur Förderung der angewandten Forschung e.V., München (DE)

(72) Inventors: Thomas Höche, Halle (Saale) (DE); Georg Schusser, Halle (Saale) (DE); Michael Krause, Halle (DE); René Feder, Leipzig (DE); Falk Naumann, Leipzig (DE)

(73) Assignee: Fraunhofer-Gesellschaft zur Förderung der angewandten Forschung e.V., München (DE)

(21) Appl. No.: 19/158,262

(22) PCT Filed: Feb. 19, 2024
(86) PCT No.: PCT/EP2024/054108

§ 371 Date: Aug. 20, 2025

(30) Foreign Application Priority Data
Feb. 20, 2023 (DE) 10 2023 201 418.1

(51) Int. Cl. B29C 59/16; B29D 11/00; B29L 11/00

(52) U.S. Cl. CPC B29C 59/16; B29D 11/00326; B29C 2791/009; B29L 2011/0016

(57) ABSTRACT

This disclosure describes a method for producing a functional element that includes a substrate made substantially of a polymer. On at least one surface of the substrate, there is at least one zone with a distinct surface texture. The method involves irradiating a specific surface region of the substrate with laser radiation during a laser-processing step. This irradiation induces a change in the volume of the polymer near the surface, caused by the interaction between the laser radiation and the polymer. The result is a permanent change of the surface texture within the targeted zone. The substrate is composed of a hydrous polymer, and the process is optimized by selecting a working wavelength of the laser-processing operation such that the polymer's degree of absorption is appropriate. This selection is based on a functional relationship among the laser wavelength, the polymer's water content, and its absorption characteristics, ensuring precise surface modification.

### CROSS REFERENCE TO RELATED APPLICATIONS

This application is a US national stage filing under 35 U.S.C. § 371 of International Application No. PCT/EP 2024/054108 filed Feb. 19, 2024, which claims priority to German Patent Application No. 102023201418.1 filed Feb. 20, 2023, each of which is incorporated herein by reference in its entirety.

### TECHNICAL FIELD

This disclosure relates to a method for producing/manufacturing a functional element comprising a substrate consisting of a polymer, at least one surface of said substrate having at least one zone with a surface shape that deviates from a surface shape in a surrounding of the zone.

### BACKGROUND

A preferred field lies in the production of optical functional elements (optics elements) for influencing the propagation of light in the event of an interaction with the functional element, for example, for optics elements for ophthalmic purposes.

In the method, the generation of a zone in a laser processing operation involves irradiation of a surface region of the substrate with laser radiation in such a way that a change in volume of the polymer is generated in a surface-near volume region of the main body in the irradiated region by way of an interaction of the laser radiation with the polymer, and this volume change leads to a (lasting) change of the surface shape in the zone.

A method of this type is disclosed in document EP 2 184 127 B1. In a method variant for generating a permanent marking for an optics element consisting of a polymer that is transparent in the visible spectral range, beam parameters of laser radiation with wavelengths from the near infrared range are set in such a way that a laser-induced volume increase is generated in the irradiated surface-near region without the polymer being destroyed. The generated structural elements of the marking are raised vis-á-vis the adjacent, non-irradiated regions. The assumption is made that the polymer swells up and/or optionally also melts in part under the influence of the incident laser radiation and solidifies again once the irradiation has been completed, and so a zone of reduced density or increased volume in comparison with before the irradiation arises in the surface-near irradiation region. If the power density of the laser radiation is not too high, the irradiated region may maintain a largely intact surface which stretches smoothly and with continuous curvature over the region of increased volume like a skin. In this way, a lens element with a convex lens surface can be generated in an irradiated region. A microlens array may be formed if a plurality of adjacent irradiation regions are irradiated.

WO 2020/180817 A1 discloses a method in which an ophthalmic lens with a stipulated optical refractive power is provided, wherein the ophthalmic lens has a surface with a base curvature that corresponds to the stipulated optical refractive power. The surface of the material is exposed to sufficient laser radiation to locally reshape the material to form a multiplicity of lenses on the surface, wherein the lenses each have a corresponding optical refractive power that differs from the stipulated optical refractive power of the ophthalmic lens. The method is intended to work with substrates made of inorganic glasses and with substrates made of organic polymers.

It could therefore be helpful to provide a method of the type described herein that is suitable for series production and allows the systematic production of structured functional elements with highly reproducible properties. Also disclosed herein is a device suitable for performing the method and providing corresponding functional elements.

### SUMMARY

We provide a method that is suitable and designed for producing, i.e. manufacturing, a functional element comprising a substrate consisting of a polymer, at least one surface of said substrate having at least one zone with a surface shape that deviates from a surface shape in surroundings of the zone. In this context, the term “zone” denotes a spatially limited area that is enclosed by a more or less sharply defined “zone boundary” and transitions in the region of the zone boundary into the regions of the surface located outside of the zone. The untreated surface may e.g. be flat (e.g. like in a plane plate) or have a base curvature contingent on the function of the functional element (e.g. like in a spectacle lens). Thus, a form of the surface shape that deviates from the base curvature is present in the region of the zone.

Accordingly, a zone denotes a surface-near structure with a specific shape and size. For example, the zone may be characterized by a lateral extent in at least one direction, a height and specifications regarding the shape of the surface or its curvature within the zone boundary. The lateral extent may also be specified by way of a diameter or aperture of sufficiently round zones. The height is the maximum distance of the surface in the region of the zone from an imaginary extension of the surface of the surroundings outside of the zone. A convex surface that is raised above the surface of the surroundings and has a mean radius of curvature smaller than that of the surface of the surroundings has a positive height; the height may also be negative in concave zone surfaces.

We also provide the generation of a zone in a laser processing operation that involves irradiation of a surface region of the substrate with laser radiation in such a way that a change in volume of the polymer is generated in a surface-near volume region of the substrate by way of an interaction of the laser radiation with the polymer, and this volume change leads to a change of the surface shape in the zone. After the laser processing has been completed, a changed surface shape vis-á-vis the surroundings remains in the zone. The change in the volume is a change in the specific volume and is implemented non-destructively below the ablation threshold, i.e. without material removal and without relevant thermal or photochemical decomposition of the irradiated polymer.

We further provide a step of the method which is the provision of a substrate substantially consisting of a water-containing polymer that has an absorptance at an operating wavelength of the laser processing operation, said absorptance being selected or set taking into account a functional relationship between the wavelength of the laser radiation, the water content of the polymer and the absorptance. The absorptance specifies the fraction of incident radiation that is absorbed (as does the absorption coefficient). The absorptance may assume values between 0 and 1.

### BRIEF DESCRIPTION OF THE DRAWINGS

FIG. 1 shows the transmission (in percent) as a function of the wavelength (in nm) for selected polymers.

FIG. 2 shows a diagram regarding the dependence of the absorption of water on the wavelength.

FIG. 3 shows diagrams regarding the influence of a drying treatment on the water content or the weight of a polymer substrate.

FIGS. 4A and 4B show cross-sectional profiles through microlens elements, wherein FIG. 4A shows the lens geometry without drying the substrate and FIG. 4B shows the lens geometry after vacuum drying.

FIG. 5 shows a graphical illustration of the time dependence of the attenuation of a laser beam through a polymer substrate in its supplied state, without a preceding drying operation.

FIG. 6 shows a graphical illustration of the time dependence of the attenuation of a laser beam through a polymer substrate after a preceding drying operation.

FIG. 7 shows three surface scanning operations with different filling directions for local heat management during the production of a convexly arched, circular microlens.

FIGS. 8A and 8B show different irradiation strategies, wherein a circular zone is irradiated successively along four equidistant ring-shaped trajectories of varying diameters.

FIGS. 9A and 9B each illustrate an azimuthal offset for starting points of a traversal for equidistant ring-shaped trajectories.

FIG. 10A and FIG. 10B show a height profile of microlenses of a microlens array (FIG. 10A) and a light-microscopy recording of an associated processed region with a multiplicity of similar microlenses (FIG. 10A).

FIG. 11 shows a schematic illustration of laser trajectories for generating an elliptical surface structure by irradiation with four concentric elliptical trajectories, from outside in.

FIG. 12 shows a schematic illustration of straight-lined laser trajectories for generating a rectangular surface structure by filling the rectangular contour with parallel lines.

FIG. 13 shows a schematic illustration of the laser trajectories for generating an open, Z-shaped zone.

FIG. 14 shows a schematic illustration of a processing strategy with elliptical laser trajectories, which are arranged next to one another with an offset in a spatial direction.

FIG. 15 shows, in partial FIGS. 15A to 15E, a selection of different possible zone geometries.

FIGS. 16A to 16C show schematic cross-sections through zones of different surface shapes.

FIG. 17 shows, on the left, a light-microscopy image and, on the right, a detail of a microlens array in an insufficient adaptation of the processing sequence to the poor thermal conductivity of the polymer substrate.

FIG. 18 shows a schematic flowchart of a method for defining the processing sequence of zones in a processing pattern that takes account of the poor thermal conductivity of the polymer substrate.

FIG. 19 shows, in four partial figures, the simulation-determined temperature distribution in a spectacle lens when generating a microlens array in a peripheral viewing region at four temporally successive times.

FIG. 20 shows light-microscopy images of a microlens array produced with optimized heat management, with increasing magnification (cf. FIG. 17).

FIG. 21 shows the relative change in height of microlenses as a function of different aging temperatures.

FIG. 22 shows a scanning electron microscope image of the cross section of a microlens array on a multifocal spectacle lens that was generated through a hard lacquer layer.

FIG. 23 shows a scanning electron microscope image of the cross section of a microlens array on a multifocal spectacle lens that was provided with an inorganic multilayer stack through a hard lacquer layer after laser swelling.

FIG. 24 shows a diagram with a comparison of the lens geometry of a microlens before (V) and after (N) the deposition of an inorganic layer stack.

FIGS. 25A and 25B show a cross-sectional profile of a regionally concave microlens (FIG. 25A) in a polymer substrate and, in FIG. 25, the scanning electron microscope image of the cross-sectional area, wherein the surface shape was modified in a targeted manner by a post-coating method.

FIGS. 26A to 26C show schematic cross-sectional illustrations for explaining options of inverting the surface shape in the region of a zone by coating.

FIGS. 27A to 27C show a schematic plan view (FIG. 27A) and a schematic section (FIG. 27B) of a randomly distributed microlens structure and, in FIG. 27C, a surface-filling regular distribution of substantially hexagonal microlenses.

FIG. 28 shows an exemplary embodiment of a laser processing device for producing functional elements according to the method explained herein.

### DETAILED DESCRIPTION

According to a strict definition, a polymer is a chemical substance consisting of macromolecules. The term “polymer” describes a material that essentially consists of a polymer or has a polymeric material as an essential constituent. The term polymer thus refers to a polymer material that predominantly or mainly consists of a polymer or of macromolecules and additionally contains or may additionally contain small amounts of further substances that are not macromolecules. A polymer may contain (one or more) additives that modify properties. Polymers, especially those with additives, are frequently also referred to as plastics.

Our method is based on the irradiation of a polymer using a laser beam, wherein the optical transparency of the polymer to the respective laser wavelength allows interaction in a volume region that is below the immediate surface in the incoming radiation direction. In particular, the method is suitable for polymers that exhibit partial transparency at the operating wavelength, i.e. at the laser wavelength used for laser processing purposes. In other words, the polymer to be processed should exhibit partial absorption for the utilized laser wavelength, i.e. not be completely transparent or completely absorption-free in the vicinity of the laser wavelength. Strictly speaking, this partial transparency initially is a specific property of the dry polymer, e.g. a polymer that has been freed from all physisorbed water by vacuum heating.

A measure of this partial transparency is the absorptance, which should be greater than zero and less than 1 in the vicinity of the laser wavelength. The absorptance selected or set or used for laser processing purposes may e.g. be from 2% to 50%, in particular 5% to 40%.

Many polymers have the capacity of absorbing a small amount of water (generally no more than a few weight percent (wt. %)). The extent of water absorption in this context depends firstly on the chemical structure of the polymer (e.g. polar or nonpolar), but also on ambient conditions (absorbing water via the air or by direct contact with water) and the time of exposure in water-containing surroundings. Cyclic olefin copolymers (COC), for example, should exhibit a particularly low water absorption in the order of only 0.01 wt. %, whereas polyamides should be able to absorb relatively large amounts of water (up to 10% of their inherent weight), and e.g. the water absorption of PMMA can be approx. 2 wt. %.

We have recognized that the water physisorbed in polymer substrates may contribute significantly to the absorption behavior and the degree of absorptance especially in specific wavelength ranges. For example, a structural modification to a polymer optics substrate, which may be made to swell up locally given a typical water content, can no longer be made to swell up following extensive drying. Therefore, controlling the water content allows the absorptance to be set precisely for a given wavelength within certain wavelength ranges. Conversely, it is also possible in some instances to select a suitable laser wavelength that leads to a definable absorption behavior for a specific polymer with a given water content, with the selection of available laser wavelengths naturally being limited. Thus, for a specific application and taking account of determinable functional relationships between laser wavelength, water content and absorptance, it is possible in a targeted manner to provide a substrate made of a polymer material that has a selected water content dimensioned such that the substrate has a desirable absorptance for the processing at the operating wavelength provided for the irradiation. Thus, the water content is an actively influenceable “set screw” for setting a desired absorptance.

We currently assume that the water is present in physisorbed fashion between the entangled polymer chains and is converted into the gaseous phase by irradiation with the laser should the energy input be sufficient. The accompanying increase in volume of the polymer material causes a pressure increase in the interaction volume, whereby the gaseous water acts as a driver for the polymer that has been softened but not structurally damaged by the increase in temperature. The processing parameters should be set in such a way in the process that, on the one hand, the water (asymmetric molecule which can be excited to vibrate) is mildly activated and, on the other hand, the polymer also has a certain basic temperature so that it can untangle, and the free volume may increase. By preference, the polymer is a thermoplastic polymer. If the water agglomerates absorbed in the polymer have only very small volumes (in the order of a few nm³ or less), as is for typical polymers for optical applications, then only very small cavities that as such are not resolvable by light or scanning electron microscopy and are irrelevant to the optical properties arise when the polymer swells up.

The assumption is made that water bound in the polymer (provided the content is not too large) may be excited by the laser radiation to obtain an increase in the free volume. Input coupling laser radiation into a suitable amount of water makes a contribution to the absorption that is dependent on the water content and the wavelength and thus influences the absorbance of the water-containing polymer. Within certain limits, the heat introduced (by exciting the water bound in the polymer) may be adapted for process optimization purposes, e.g. by controlling the laser output power and/or by controlling the irradiation time effective at one location.

Against the background of this insight, our method enables a reproducible process regime such that functional elements having the sought-after properties may be produced systematically and within small tolerances.

The method is of particular interest to applications in which optically effective, surface-near structures are intended to be generated. This is possible because the local, damage-free swelling up or shrinking of the polymer generates structures with defined optical properties, and hence it is possible to process components for applications, e.g. in the field of micro-optics or medical engineering, in a targeted manner in accordance with the specific requirements. For instance, spherical or aspherical or astigmatic or cylindrical microlenses may thus be generated. Prismatic structures are also producible. In lens-like surface structures, it is possible to generate both optically focusing or diverging and also light-guiding or scattering optical structures. However, it is also possible to produce functional elements for other, non-optical fields of application, e.g. for microfluidics or for test structures for determining the layer adherence of inorganic functional coatings on polymer substrates.

The form of the zones, i.e. the form of an area enclosed by a zone boundary, may be adapted in a targeted manner to the intended purpose. Circular zones are envisaged in many instances. For example, this allows the generation of microlenses, which look like round optics parts and can be characterized by an aperture or a diameter. Zones with an aspect ratio that differs from one between a longest and a shortest lateral extent are also possible, e.g. elliptical zones or rod-like long zones with an aspect ratio of more than two. A zone may have a polygonal form, e.g. a rectangular form, in particular a square form, or a polygonal form with only three or more than four corner regions. As a rule, corner regions are slightly rounded due to technical reasons.

The number of zones may also vary depending on the intended use. A single zone on the surface is sufficient for some applications. For example, in a multifocal lens, a zone of greater curvature (for the near region) may be worked into a region of moderate base curvature (for distance vision). In the field of micro-metrology, it is e.g. possible to exactly set the receptacle volume of a small bowl by virtue of the base region being irradiated such that this results in arching that leads to a sought-after reduction in the receptacle volume. Similarly, a minor yet very exactly predeterminable increase in the receptacle volume would be possible by irradiating the base region by a laser.

Many applications envisage embodiments that have a multiplicity of similar or disparate, i.e. dissimilar, zones that may be distributed over a surface according to a specific pattern. This is the instance for e.g. microlens arrays.

It is assumed that polymers in their original supplied state are generally not optimally suited for a planned production process. For example, it may be that the nominal water content in the supplied state is significantly less or significantly more than the water content that leads to the absorptance required within the process. Some method variants solve this problem by a controlled modification of the water content of the polymer of an initial substrate to set the absorptance desired for the laser processing operation, wherein the controlled modification comprises at least one drying operation for reducing the water content and/or at least one loading operation for increasing the water content.

As a rule, method variants in which the controlled modification of the water content comprises a combination of at least one drying operation and at least one loading operation performed before or after the drying operation are particularly advantageous within the sense of a reproducible process regime.

For example, to set the water content in a targeted manner, polymer substrates to be processed may initially be dried in an oven to below their softening temperature. Thermal aging in vacuo or under negative pressure is particularly advantageous here since the expelled water is guided away and therefore cannot be reabsorbed. Subsequently, the dried components may be exposed to water or a moist ambient atmosphere in a defined manner over a defined period of time so that a specific water content is set in the workpiece. The relative decrease in weight or increase in weight may be measured in the process, for example, gravimetrically or with the aid of spectroscopic methods (e.g. FTIR, Raman spectroscopy). Thus, drying is initially carried out here to then reintroduce water in a targeted manner starting from a defined, low initial value of the water content.

In an alternative procedure, the polymer could initially be aged to saturation with water by aging in water and/or humidity and could subsequently be dried in a defined manner. With this, the loading operation hence precedes a drying operation. In both instances, the combination of drying operation and loading operation creates a defined initial state for the respective subsequent operation, whereby precise final results are systematically obtainable.

In an alternative to that or in addition, varying the process parameters makes it possible to react to slight deviations of the water content from a target water content, and so it is optionally possible to manage without costly measures for exactly setting the water content.

Series of experiments may be performed to ascertain the most exact knowledge possible as regards the functional relationship between laser wavelength, water content and resultant absorptance for a specific polymer material. In doing so, the time/weight curve up to weight constancy may be recorded for a specific sample shape, e.g. for exactly determining the moisture absorbance or water absorbance of a polymer. For example, water absorption may be tested according to the EN ISO 62 standard.

However, accurate knowledge of the absolute values for the water absorbance or water content is not mandatory. In some method variants, an experimental determination of the functional relationship between the wavelength of the laser radiation and the water content of the polymer and/or a measurable quantity dependent on the water content is performed by way of a multiplicity of trials for a characteristic map or data for a corresponding characteristic map to be ascertained. Hence, the characteristic map represents the behavior of the polymer relevant here. Process parameters for the laser processing may be set on the basis of data from the characteristic map. In particular, the optical and rheological properties of the polymer, the selected laser parameters (including laser wavelength) and the (local) water content of the polymer in the region provided for irradiation are decisive process parameters in this respect.

With the aid of a series of experiments it is also possible e.g. to create a database with database entries for a multiplicity of different polymer materials and parameter sets dependent on the polymer, a radiation-traversed thickness of the substrate and the absorption and/or water content. Suitable recipes for laser processing may be derived therefrom at a later stage, optionally in the style of a lookup table.

In some method variants, an absorption measurement is performed to determine the absorptance of the polymer for at least one wavelength of the laser radiation before and/or during the laser processing operation. For example, the absorption measurement may comprise a measurement of the attenuation of a laser beam passing through the substrate of the functional element.

As already mentioned, our method is used in a preferred field of application to produce optical functional elements, which are also referred to within this application as optics elements for short. For this application, a zone may be designed as an optically effective lens. Hence, the surface shape in the zones present during intended use determines the optical effect of the individual lenses, which may have a converging or diverging effect.

For applications in the field of ophthalmic products, the polymer should be as transparent as possible in the visible spectral range. For these situations, in particular, preference is given to laser processing systems and processes in which the laser radiation has a laser wavelength in the wavelength range of between 1.1 μm and 9.2 μm. As a result, the interaction mechanism between laser radiation and water-containing polymer can be used particularly advantageously. In particular, the use of thulium fiber lasers with an operating wavelength at approx. 1.9 μm appears advantageous. One reason for this, inter alia, can be found in the high absorption by water but concurrent low absorption by the polymer.

We have also gained important insight in relation to details of an advantageous process regime. For example, to generate a circular zone, the region in which the zone should be created may be irradiated with laser radiation over its entire area.

By contrast, preferred embodiments provide for the generation of a zone to involve the use of a focused laser beam that, in the region of the zone, has a focal region with a diameter that is substantially smaller than the mean diameter of the zone to be generated, and for the focal region to be guided over the zone along at least one trajectory in accordance with a processing pattern such that different locations in the zone are exposed once or multiple times to focused laser radiation temporally in succession. Thus, a “trajectory” is a processing path followed once or multiple times by the focused laser beam. This allows the topography of the surface, i.e. the surface shape within the zone, to be set in a controlled and well-defined manner. This is particularly important for optical applications if zones should have a specific optical effect (for example, focusing, diverging). By way of this scanning process regime along trajectories, it is, for example, possible to set the focal length of a lens with great precision. For example, the focal region may have a mean diameter in the order of 10 μm to 20 μm, and a zone can be multiple times larger, e.g. up to 400 μm.

According to a development, provision is made for some or all locations in a zone to be exposed to laser radiation to be traversed not only a single time but multiple times, i.e. two times, three times, four times or even more frequently, wherein each traversal involves the introduction of only a portion of the laser energy to be introduced overall. In particular, individual, multiple or all trajectories may be traversed multiple times. As a result, the heat in the substrate generated in locally delimited fashion may be distributed to a certain extent between the traversals, and local overheating may be avoided. Furthermore, the overall energy to be introduced can be controlled more precisely than in only a single traversal.

To generate a zone in a method variant, the focused laser beam is successively guided in a scanning direction along straight adjacent spaced apart trajectories within a surface scanning operation. For example, a ratio between the spacing and the main focal diameter may be 2:1 to 5:1. Thus, the trajectories are used to restrict the energy input by the laser to the shape of the zone to be obtained, for example, a circular or rectangular shape. By preference, a zone is not only irradiated once in one scanning operation but multiple times in different scanning directions such that a surface scanning operation is followed by at least one further surface scanning operation with a further scanning direction oriented at an angle to the scanning direction. This procedure takes account of the fact that polymers generally have very poor thermal conductivity, wherein an overall sufficiently uniform irradiation over the surface is rendered possible by scanning in different directions. By setting suitable distances between adjacent straight-lined trajectories, it is possible to influence the overall level of heat input. The same is also possible by controlling the traversal speed of the focus along a trajectory.

To generate a zone in another embodiment, the focused laser beam is guided over the zone along two or more closed trajectories of different sizes. It is frequent that more than two trajectories are provided, for example, three or four trajectories of different sizes. The trajectories may be similar to one another, i.e. have a similar course but different sizes of the covered or encircled region. The radial distances between trajectories and their number may be matched to the desired final shape.

To generate a circular zone in one configuration, the focused laser beam is guided over the zone along two or more concentric circular trajectories of different diameters. It is frequent that more than two circular trajectories are provided, for example, three or four circular trajectories of different diameters. The radial distances between circular trajectories and their number may be matched to the desired final shape.

To achieve a heat distribution that is as uniform as possible, provision may be made for the starting points of trajectories of different sizes or diameters to be located offset from one another in the circumferential direction in the event of irradiation along closed trajectories, e.g. circular trajectories.

It may sometimes be that a trajectory, e.g. a closed encircling trajectory such as e.g. a circular trajectory, is irradiated only once, i.e. in a single traversal; this may be sufficient in particular whenever the sought-after heat input is very small. By preference, the laser beam is guided over the trajectory with a predetermined number of multiple traversals for at least one of the trajectories, preferably for all trajectories. As a result, the heat generated during one traversal can be distributed within the polymer during the period of time before the next traversal, and so relatively large amounts of energy may also be deposited in stages in a material-sparing fashion.

Different strategies are possible for process regimes with the generation of closed trajectories, in particular concentric circular trajectories. In one variant, a first trajectory, e.g. circular trajectory, is initially irradiated with a predetermined total number of traversals, and this is followed by at least one second trajectory of a different size or a different diameter being irradiated with a total number of traversals provided for this trajectory. Thus, each closed trajectory is irradiated to the entire envisaged extent before processing in the region of the second trajectory is started. Sequencing of the trajectories may be implemented both from out to in (e.g. from a larger diameter to a smaller diameter) and conversely from the inside out, but other sequences are optionally also possible.

In another processing strategy, a first iteration, i.e. run, involves irradiation of each of the trajectories of different sizes with a number of traversals that is lower than the envisaged total number of traversals for the respective trajectory, e.g. exactly once. Then, two or more further iterations/runs are performed, in which some or all trajectories of varying, i.e. different, sizes or diameters are irradiated once again with a number of traversals that is lower than the predetermined total number of traversals for the respective trajectory. This procedure is continued until each of the trajectories has been irradiated with the envisaged total number of traversals.

A particularly uniform heat distribution and sparing processing arises if each of the trajectories to be irradiated, e.g. circular trajectories, is only traversed once in each iteration. However, this is not mandatory.

On account of the targeted use of functional relationships between water content, polymer material, laser wavelength, etc., it is possible within the scope to design the surface shape within the zones very differently in a defined manner. Some method variants generate zones that have a convexly arched surface shape in a portion of the zone or over the entire zone. These may subsequently have an effect in optical functional elements such as converging lenses. In the process, the surface is preferably generated in such a way that it is curved spherically or aspherically with rotational symmetry. In the process, focal lengths can also be set for the surface shape in a targeted manner. Thus, the form of the surface can be set largely independently of the form of the zone (e.g. round or polygonal).

However, it is also possible that zones that have a concavely arched surface shape in the entire zone or in an e.g. circular partial zone are created. In this context, use is sometimes made of the insight that in water-containing polymers, the laser radiation may also be used in a targeted manner for local drying by expelling water, whereby a more certain material shrinkage can be brought about in a targeted manner. Thus, the generation of a concavely arched surface shape involves irradiation by the laser radiation preferably such that locally restricted drying of the polymer below the softening temperature of the polymer is induced, and this leads to a reduction in the specific volume of the polymer while forming the concavely arched surface shape.

However, this is not the only option for forming concavely arched surface shapes. In some variants, the generation of a concavely arched surface shape in an e.g. circular partial zone of a zone involves irradiating the region to be irradiated with laser radiation in such a way that an increase in the specific volume in a radially outer region, e.g. an annular region, is greater than in an inner partial zone surrounded by the outer region (e.g. circular region). The idea here is that of e.g. generating a heat ring, in the interior of which a heat buildup may arise. However, this may contribute to a defined topographic structure formation. Hence, in this method variant a concave surface with a diverging effect in optical applications is formed, and this surface is surrounded by an edge that is elevated vis-á-vis the surroundings of the zone.

In very general terms, it is possible e.g. to irradiate a zone in such a way that this leads to a disparate distribution, rotationally symmetric with respect to the center of the zone, of an energy input caused by the laser radiation, and this leads to differently pronounced changes in volume.

In many instances, the processing task consists of generating multiple similar or disparate zones in a region of the surface to be structured, said zones being distributed over the surface at different locations in the region to be structured, in accordance with a predeterminable pattern.

An example to this end is the production of a microlens array or the production of a multifocal spectacle element for correcting a visual disorder, in which a spatially limited region should be additionally structured with microlenses. We have recognized that specific problems with shaping may arise as a result of the fact that, in view of the low thermal conductivity of polymers (e.g. approximately 0.19 W/m*K for PMMA), the energy input when generating a microlens may influence the shape and size of a further microlens that is situated in the immediate neighborhood and processed in quick succession. Therefore, we propose special measures for a global heat management or global temperature control, especially for such instances. Such heat management on macroscopic length scales is particularly important, inter alia, if the process window in view of the required energies to be introduced for the change in volume is particularly tight, for example, as for lenses that are relatively small and flat. According to a development, such processing tasks provide for the zones to be generated successively in accordance with a heat-input-optimized processing strategy, by preference wherein the generation of a first zone at a first location is followed by the generation of a distant second zone before a third zone closest to the first zone is generated. This results in a particularly advantageous strategy for distributing the thermal load with the object of not generating lenses in preheated areas on the polymer substrate. The heat input is also relevant in view of the water content in the polymer since the laser-induced increase in volume (laser swelling) can only be observed in the presence of a sufficient amount of water, and only drying, which might subsequently lead to unwanted shrinkage, could be determined with insufficient energy input.

To ascertain the processing strategy according to a development, a processing sequence of the zones is defined using temperature criteria, distance criteria and zone size criteria, wherein a finite element simulation is carried out, by preference to ascertain the processing strategy. As a result, it is possible to define the sequence in which the zones are processed in succession to ensure that the local temperature of the substrate does not exceed a predeterminable temperature threshold value at any time or ensure that it follows a similar optimization criterion despite the poor thermal conductivity of the polymer. As a result of a corresponding simulation, it is possible given a suitable definition of the target functions of the process to ascertain an optimized processing sequence and perform the structuring process accordingly.

According to a development, multiple disparate zones are generated in a region of the surface to be structured, said zones being distributed over the surface at different locations in the region to be structured, in accordance with a laterally random distribution. For example, the zones may differ in terms of their shape and/or their size and/or their optical effect. In such a random distribution, some zones or all zones may have an asymmetric polygonal shape. For example, a zone may have three, four, five, six, seven or more corners and a corresponding number of lateral edges. The irregularly shaped zones may form a surface-filling arrangement, in such a way that with the exception of the zones located at the edge of a structured region, every zone immediately adjoins an immediately neighboring zone across a corner or lateral edge in all lateral directions. The structured region may be filled, without gaps, with optically effective irregularly designed microlenses with refractive power (generally positive but optionally negative as well). By preference, the surfaces of the zones have randomly distributed curvatures and heights, in such a way that the zones also have a randomly distributed optical effect. For example, the distribution of the zones may be predetermined using a Voronoi tessellation.

Advantageously, an optical functional element of this type (with a laterally random distribution of zones, especially in surface-filling fashion) may be designed as e.g. a beam shaping element, in particular as a diffuser. When partly coherent or coherent radiation (e.g. from a laser) passes therethrough, it can generate an intensity distribution in the far field thereof that is more uniform than in a microlens array with uniformly distributed microlenses of similar dimensions.

For further explanations regarding the functionality and possible applications of random microlens arrays, reference is made to the journal article “From regular periodic micro-lens arrays to randomized continuous phase profiles” by M. Cumme and A. Deparnay in: Adv. Opt. Techn. 2015; 4(1): 47-61. Methods and devices described in this application may advantageously be used for the production of such random microlens arrays.

According to a development, multiple preferably similar zones are generated in a region of the surface to be structured, said zones being distributed over the surface at different locations in the region to be structured in surface-filling or gap-free fashion, in accordance with a regular distribution. The zones may fill the region to be structured in the style of a tessellation. Some or all zones may have a symmetric polygonal shape. For example, a zone may have the shape of a triangle, a quadrilateral or a hexagon. The zones may form a surface-filling arrangement, in such a way that with the exception of the zones located at the edge of a structured region, every zone immediately adjoins an immediately neighboring zone across a corner or lateral edge in all lateral directions. The structured region may be filled, without gaps, with optically effective designed microlenses with curved surfaces.

Especially when producing optical functional elements, for example, for the production of zones of special refractive power in multifocal spectacle elements, it may be advantageous if completion of the laser processing operation is followed by a controlled heat treatment and/or drying treatment for the functional element to stabilize the structures generated by the laser processing prior to an intended use at the ambient temperature. For example, postprocessing may comprise a heat treatment below the softening temperature of the polymer to stabilize the lens geometry.

In the context of polymer-based optical functional elements, functional coatings (e.g. hard lacquer layer, antireflective coating, . . . ) are widespread. We have recognized that it is possible, even for methods of the type considered here, to coat the surface to be structured with a functional layer or sub-layers of a desired coating before the laser processing operation, between selected steps of the laser processing operation and/or after the laser processing operation has been completed. According to a development, the type of coating (layer materials, layer structure, etc.) and/or parameters of the coating process (e.g. temperatures during the coating) can be matched to the water content and/or a water absorption capacity and/or a water release capacity and/or a structural relaxation capacity of the polymer, in such a way that the coating makes a contribution to the shaping and/or the stabilization of the surface shape in the region of the zone. For example, an important selection criterion may be the transmissivity or permeability of the coating to water. A substantially water impermeable coating may be used to stabilize the surface shape generated by a laser processing operation against gradual changes in shape during the intended use, by virtue of water loss or water absorption being inhibited or completely suppressed. In an alternative to that or in addition, a stabilization of the surface shape acting predominantly mechanically is also possible as a result of a stable functional coating.

If a coating and/or a coating operation is natured such that it has a quantifiable influence on the surface shape of a zone, i.e. has shape-changing properties, then this can be taken into account in the overall process. According to a development, the laser processing operation is carried out in such a way that the surface shape generated thereby does not correspond to the sought-after target surface shape but has a defined shape deviation vis-á-vis the latter. Then, a minor change in shape can be caused by applying the coating, whereby the sought-after target surface shape can be set with great accuracy. Hence, a coating may be used to trim the surface shape. The change in shape can usually be described as a change in the surface curvature. For example, the latter may be reduced, with it optionally also being possible to modify the sense of curvature (inversion).

A significant advantage of the laser-based method consists in the option of generating zones of varying form and size with a positional distribution on a substrate that can be predetermined in application-specific fashion and freely by programming the laser processing system. In correspondingly well-equipped and adjusted systems, it is possible to work with a positioning accuracy in the order of 1 μm or better, e.g. down to 0.5 μm. The positioning accuracy specifies the process-related tolerance with which zones may be generated exactly at the location on the surface predetermined therefor. Regular periodic arrays of zones, as desired for some microlens arrays, are producible therewith, inter alia. To generate an array with a multiplicity of similar or disparate zones, it is consequently possible to predetermine a position distribution of the zones with individually predetermined positions for each of the zones, and the zones can be generated successively in a laser processing operation at the predetermined positions with a positioning accuracy specific to the laser processing operation.

There is great freedom of design with respect to the distribution of the zones, which may also be arranged deliberately irregularly. In some embodiments, positions of the position distribution in one or more regions of the surface deviate from the closest positions of a two-dimensionally periodic position distribution by a lateral offset that is greater than the positioning accuracy and less than a periodic distance from the closest position of the periodic position distribution. Hence it is possible to precisely generate irregular position distributions. In the process, one or more or all zones may have e.g. a circular form, an elliptical form, a polygonal form, in particular a rectangular form or a rod-shaped form with an aspect ratio of more than two between length and width. Other forms are also possible.

The arrangement of a plurality of the zones can thus also be easily adapted to external requirements. For example, should microlens arrays be generated for the system integration, the arrangement of which is adapted to other system components such as micro-LEDs or pixels of a camera chip, then the minor deviations of this arrangement from a perfect grid can be accounted for by measuring and generating a suitable arrangement of individual microlenses. The arrangement of a plurality of the zones may thus also be easily and individually adapted to inhomogeneities of substrates or geometric peculiarities of preprocessed semifinished products. Hence, this can be used to generate a microlens array adapted to a different optical element. Thus, this arrangement must only still be aligned properly once relative to the other elements.

In principle, the method can be used in many fields of application in which polymer-based optics are used. For example, the method can be used to correct the shape of molded lenses or else for optically effective structuring of free-form optics. The use for producing flat optics, e.g. for the use in microscope or lighting optics, is also possible. Corresponding components may then find use in the field of automotive, display technology or microscopy/camera inspection.

However, particularly great potential for application of the manufacturing method is found in the field of medical engineering, in particular for the manufacture of individualized, multifocal optics in the form of spectacle lenses or intraocular lenses (IOLs). Since only molding manufacturing techniques have been used for this to date, but the described method offers the option of flexible structuring without molds, it was possible for the first time to process patient-optimized spectacle lenses, e.g. for myopia management in children, for progressive lenses or for multifocal IOLs. In this context, a further advantage of the method is that it allows the generation of microlenses that are optically effective but visually invisible. If necessary, regions with zones may be identified with optical aids, e.g. ellipsometrically by way of stress-introduced birefringence possible in the region of zones.

Moreover, our method may be used in the field of microfluidics, e.g. for volume calibration or the structuring of channel structures. Use in the field of product marking and batch labeling is also possible.

Away from this, the method may find use e.g. when determining the adhesion of thin layers on polymer substrates or the functional structuring of piezo or pyroelectric polymers (e.g. polyvinylidene fluoride (PVDF)).

Our method also relates to a functional element that can be obtained when the method is applied and that comprises a substrate substantially consisting of a polymer, at least one surface of said substrate having at least one zone with a surface shape that deviates from a surface shape in surroundings of the zone.

Our method also relates to a device for producing a functional element comprising a substrate consisting of a polymer, at least one surface of said substrate having at least one zone with a surface shape that deviates from a surface shape in surroundings of the zone. The device comprises a substrate holder for receiving a substrate, a laser system having a laser radiation source for emitting laser radiation at an operating wavelength and a beam guiding system for guiding a laser beam to a surface of the substrate. Furthermore, a movement system is provided for generating such relative movement between the substrate and the laser beam that the substrate can be irradiated by the laser beam at different points of a region to be structured. The device is configured to perform the method.

Further advantages arise from the description of exemplary embodiments explained below on the basis of the figures.

A few exemplary embodiments for the production of functional elements for optical applications are explained hereinafter; accordingly, these functional elements are also referred to as optical functional elements or optics elements. What is common to the exemplary embodiments is that use is made therein of a substrate that substantially consists of a polymer, i.e. a polymeric material, and that at least one zone with a surface shape that deviates from the surface shape of the substrate in the vicinity of the zone is generated or present on at least one surface of the substrate. The surface in the region of the zone may be elevated or recessed vis-á-vis the surrounding surface.

An exemplary embodiment for such polymer-optical systems using microlenses is that of multifocal ophthalmic lenses for slowing down myopia progression in children. In this context, a superimposed focus in the periphery should slow down or even entirely stop the overproportional longitudinal growth of the eye that causes myopia.

We have found ways of producing such surface-structured functional elements systematically with optical properties that can be reproduced very well and can be set on an individual basis with great accuracy. To this end, use is made of polymer substrates that have a specific or determinable water content and are processed with laser radiation at an operating wavelength adapted thereto. As a result of using the functional relationships between the wavelength of the laser radiation, the water content of the polymer and the absorptance of the polymeric material that can be influenced significantly thereby, it is possible to achieve the sought-after goals.

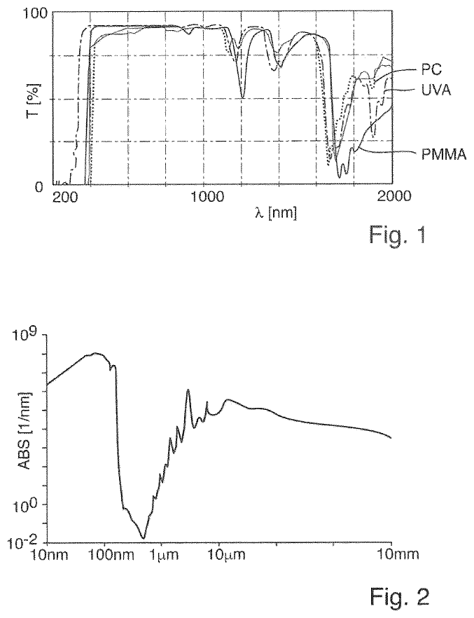

Influence of the water content on material properties and laser processing parameters For optical applications in the visible wavelength range, polymeric materials with sufficiently good transparency in the visual spectral range come into question. For some of the polymers usable in polymer-optical applications, FIG. 1 plots the transmission (in percent) as a function of the wavelength (in nm), specifically for polymethylmethacrylate (PMMA), polycarbonate (PC), cyclic olefin copolymers (COC), polyvinyl acetate (e.g. PVB) and ultraviolet acrylic (UV). Comparable curves also exist for special polymers that are optimized for medical applications, for example, those known as MR-7, MR-8, MR-10, MR-174 or CR-39, which are produced by Mitsui Chemicals, Inc. The measured curves in FIG. 1 evidence generally high transparency in the visible wavelength range (approx. 400 nm to approx. 750 nm) and a partial transparency at shorter wavelengths and, in particular, at longer wavelengths, too. In the regions of partial transparency or a specific corresponding absorptance, the materials can absorb some of the laser energy at specific wavelengths. In the examples given, this is the instance inter alia at wavelengths from the near infrared (NIR) range above 1.1 μm, in particular above 1.6 μm.

We have recognized that an essential contribution to the absorption behavior of a polymer can be made by way of its water content, and that accordingly controlling the water content allows the absorptance of the polymer to be set so precisely for a specific application or a specific wavelength range of the laser radiation that this leads to the existence of very exact design options with the aid of an exactly controllable heat input.

All aforementioned polymers may absorb water to a greater or lesser extent, for example, 0.01 wt. % up to approx. 10 wt. %. FIG. 2 makes clear that water may make a significant contribution to the absorption capacity. FIG. 2 shows a diagram regarding the dependence of the absorption of water (in 1/m) on the wavelength. For example, what is evident from this is that water sometimes exhibits significant absorption in the wavelength range above 1 μm or 1.1 μm and inter alia has a local maximum around 2 μm. From this, we have inferred that controlling the water content for a given wavelength should allow the absorptance to be set precisely and should thereby create controllable and reproducible processing conditions.

According to the present knowledge, in the method, the water stored between the polymer chains is converted into the gaseous phase under irradiation with laser radiation at a suitable wavelength and intensity. The accompanying increase in volume causes a pressure increase in the interaction volume, whereby the gaseous water acts as a driver for the polymer that has been softened but not structurally damaged by the increase in temperature. The extent of the change in volume can be fine-tuned by the process parameters, for example, the laser wavelength, laser energy, type of polymer and water content (for setting the effective absorptance during the laser processing).

For example, this interaction mechanism can be induced particularly well by laser radiation in the NIR range, for example, using thulium fiber lasers at an operating wavelength of approx. 1.9 μm. One reason for this, inter alia, is the high absorption by the water (cf. FIG. 2) but concurrent low absorption by the polymer (cf. FIG. 1). As a result of the partial transparency of the water-loaded polymer, the laser radiation may penetrate sufficiently deeply into the surface-near region of the polymer and bring about the change in volume.

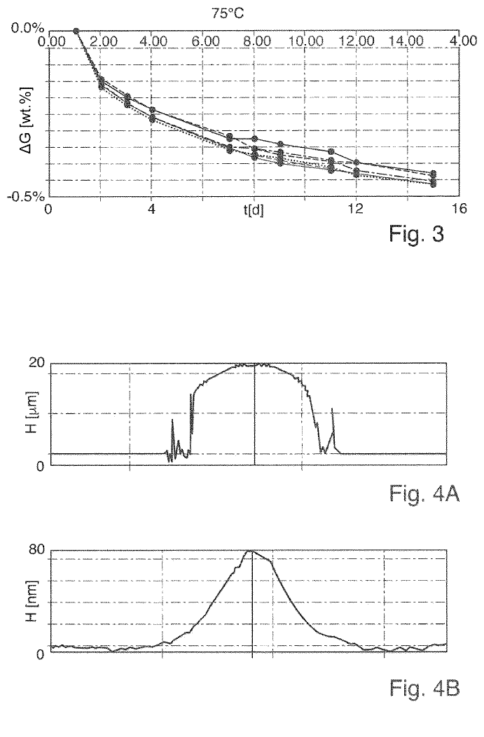

The fact that the stored water plays an essential role during this process and the interaction mechanism presumably exists as assumed was shown by series of experiments. For example, a polymer substrate made of the special polymer MR-7, which is used for high-quality spectacle lenses, was locally irradiated with laser radiation to create lens geometries with convexly arched surface shapes in the irradiated zones. The irradiated workpieces were subsequently stored for more than two weeks (x-axis in days [d]) in a vacuum oven at 75° C. The diagram in FIG. 3 shows the change AG in the weight of several polymer spectacle lens blanks made of MR-7 after being dried by way of storage in a vacuum oven at 75° C. The gradual reduction in weight due to the loss of water in the polymer material is clearly evident. This also verifies that the water content can be reduced in a targeted manner by the drying treatment in a suitable atmosphere.

FIGS. 4A and 4B show cross-sectional profiles through microlens elements created by irradiating the MR-7 material at 410 mW. FIG. 4A shows the lens geometry without drying the substrate in the vacuum oven. FIG. 4B shows the lens geometry after vacuum-drying for 14 days at 75° C. While a lens height H of more than 20 μm arises for the (water-containing) state without drying (FIG. 4A), identical laser parameters only allow the creation of an undefined buildup of approx. 80 nm height after 14 days of drying. This is assessed as a strong indication that the capability of the polymeric material to swell up, i.e. its capacity for a laser-beam-induced increase in volume, depends significantly on the water content of the polymer and accordingly can also be influenced in a targeted manner by controlling the water content.

Although the water content of a polymeric workpiece has a significant influence on the absorption behavior, there nevertheless are further influencing parameters that may have effects on the specific choice of laser parameters. These include inter alia the thickness of the material or the presence of coatings. As a consequence, it is advantageous to measure the respective partial absorption present in the run-up to and/or during the laser processing process. To this end, it is possible e.g. to perform power measurements through the workpiece to be processed. Subsequently, it is possible to use laser parameters adapted to the partial absorption present in that instance.

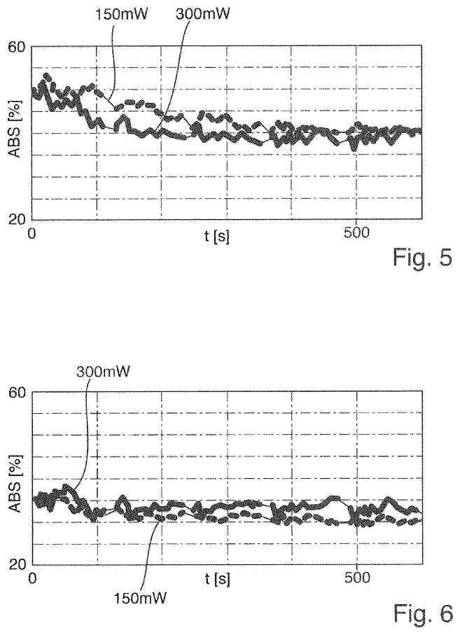

The relationships are clearly evident on the basis of the diagrams in FIGS. 5 and 6. FIG. 5 shows a graphical illustration of the attenuation ABS of a laser beam (in percent) at a wavelength of 1940 nm and a power of 150 mW or 300 mW during the passage through an MR-7 substrate approx. 1 mm thick in its supplied state, i.e. without a preceding drying operation. Under the chosen conditions, only drying and no swelling up is achieved by the interaction with the laser beam. It is evident that, especially during the initial period of the irradiation, the attenuation decreases significantly until it asymptotically reaches a state with only a small, constant absorption decrease. The comparison with FIG. 6 (attenuation with a dried lens) shows that a minor reduction in the attenuation can only be determined during a relatively short initial phase, and the attenuation thereafter only reduces to a small extent over time. Such results are assessed as a strong indication that the absorptance of the water-containing polymeric material effective during the laser processing operation depends significantly on the water content thereof and accordingly may also be set in a targeted manner by way of controlling the water content. It was also found that laser drying may be obtained by areal irradiation significantly below the threshold swelling-up fluence (fluence above which it is possible to generate a volume increase or laser swelling).

As preparation for series production, the water-content-dependent absorption behavior presented here by way of example was measured in a series of experiments, and database entries for suitable parameter sets were generated and used in dependence on material, workpiece thickness and absorption water content. For this purpose, an appropriate power measurement or beam diagnostics were performed below the sample. In an alternative to that or in addition, it is also possible to use camera inspections in transmission or in reflected light, to measure the swelled-up/dried areas by test processing, for example, outside of the target region, and highlight the necessary adaptations to the process parameters.

### Details of Selected Processing Processes

The energy input by way of a laser beam is directed to a defined heat input into the water-containing polymer below the ablation threshold. The shape of the interaction zone between laser and polymer may be set in a defined fashion laterally by the type of process regime, in particular by the choice of laser trajectories and/or by setting the beam profile. The height of the zone of modified volume may be influenced decisively by the extent of the local energy input. As a result of a suitable choice of the processing pattern, the topography of the surface may be set in such well-defined fashion in the process that the desired optical system properties may be obtained.

Thus, the topography of the surface corresponds to the surface shape of the zone or the regions within the zone boundaries which represent the transition from the adjoining region of the surface to the superstructure in the zone. In the process, it is just as possible to represent monotonic or strictly monotonic transitions as discontinuous transitions. In this context, the method may be used both for structuring a surface on the front side facing the laser beam and for generating structures on the back side through the workpiece.

We have found an important insight consists in the fact that, on account of the typically low thermal conductivity of polymers for optical applications, the design of the processing strategy should ensure operation of both a local heat management for generating an individual structure (i.e. an individual zone, for example, one microlens) and a global temperature control for producing defined optically effective overall structures, for example, microlens arrays.

FIG. 7 is used to explain an example of a local heat management when generating a circular zone Z for producing a convexly arched microlens. To generate spherical or aspherical microlenses, the energy input by the laser is restricted with the aid of the trajectories TR of the laser processing, represented by dashes, to the e.g. circular shape of the zone Z to be achieved. Within this boundary, instances of a spherical arching may, for example, be generated by a filling of equidistant lines. In this respect, the left partial figure shows the course of straight-lined trajectories TR in the event of a filling direction FR that extends from left to right. However, this results in a non-uniform heat distribution on account of the poor thermal conductivity of the polymer. To counteract this, this exemplary embodiment involves completely filling a zone multiple times in different filling directions by virtue of each completed iteration being followed by the filling being rotated through a specific angle, for example, between 30° and 60°, in relation to the previous filling and being output again (central and right partial figures). Hence, local heat buildup may be generated in the center of the trajectory, and the zone receives arching that is substantially rotationally symmetric with respect to the center of the zone.

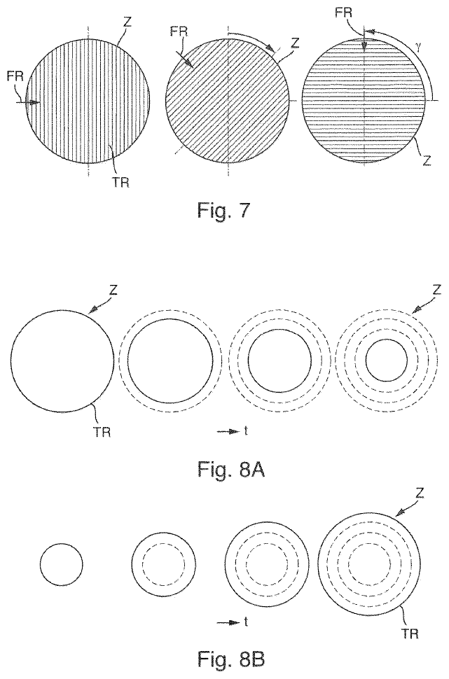

It was found that from the point of view of heat management and obtainable surface shape, it may be more advantageous to guide the region to be irradiated over the zone along two or more closed trajectories TR of different sizes. The trajectories may be similar to one another. The intention is to explain this on the basis of FIGS. 8 to 10 for circular zones. Thus, the zone is generated along concentric circular trajectories with a spacing that matches the final shape. In so doing, two different approaches may be taken in view of the assignment of laser parameters. In the figures, the ring highlighted in bold represents the ring currently being processed while the thin dashes represent the already processed rings. In the variants of FIGS. 8A and 8B, the zone is irradiated by four equidistant trajectories TR of different diameters. In the process, each individual ring (each circular trajectory) is irradiated in full using the focused laser according to the necessary total number of traversals (e.g. from one to four, five or six, hardly ever more) calculated in advance and only then is there a jump to the next ring, and the work is continued analogously. Sequencing of the rings may be implemented from out to in (FIG. 8A) or from the inside out (FIG. 8B). In so doing, each ring may be assigned an individual velocity along the trajectory. By preference, the latter may be kept the same for all traversals along a trajectory. The traversal speeds that should normally be selected differently for the rings take account of the fact that the local energy input along the trajectory is greater at slower traversals, whereby different swelling heights may arise at the start (lower) relative to the end of the trajectory (higher), even for individual traversals.

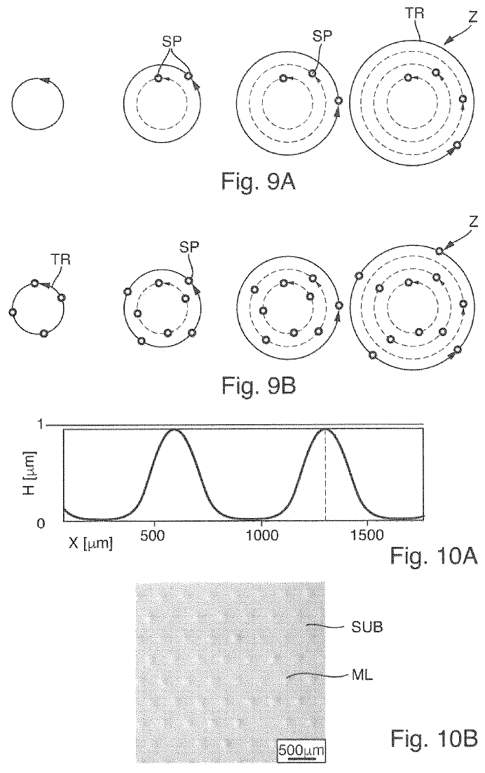

It was observed that the rings at the start tend to be similar to Landolt rings as a consequence of swelling up not yet being initiated as a result of a heat accumulation that is still too small. To prevent this, provision is preferably made for the initial points or starting points SP of the laser trajectories to be offset in a defined manner, either between the rings and/or between the respective traversals on the rings. FIGS. 9A and 9B each show the starting points SP of a traversal on a ring. It is evident that the starting points are offset from one another azimuthally. More uniform surface shapes can be generated as a result. Thus, to generate swelled-up areas (e.g. spherical microlenses) in a defined fashion, the local energy input, the number of rings, their relative spacing and the filling direction should be matched to one another to set the target geometry (especially its aperture and height) in a defined fashion. Thus, the term “aperture” represents the size of the zone within its outer circumference or zone boundary. In many instances, this is not a sharply defined boundary but a smooth transition between regions of differing general curvature. Thus, the respective rings need not necessarily be processed in succession. A deviating sequence when processing the rings is also possible. Optionally, the laser parameters should be adapted in that situation.

According to an alternative processing strategy, all trajectories provided for the generation of a zone (for example, between three and five rings) are successively swept over once by the focused laser beam before, starting at one of the rings, a next sequence of processing instances takes place, during which all circular trajectories or some of the circular trajectories are once again traversed another time. Accordingly, there is only one traversal per circular trajectory within a complete iteration, and the total number of traversals for the rings corresponds to their number. Thus, the introduced energy can be introduced very homogeneously and in location-specific fashion by the choice of high velocities or traversal speeds (for example, a few hundred millimeters per second to a few meters per second) with, at the same time, many traversals, little laser power and only very short pauses for jumps between the annular trajectories. A variation in the starting points (cf. FIGS. 9A and 9B) may additionally be implemented when necessary.

Our experience has shown that the irradiation strategy mentioned first is frequently particularly advantageous for the production of high structures; there might be limitations if the intention is to produce zones with a relatively small aperture (e.g. less than 500 μm) with concurrently a low height (e.g. less than 1 μm). The height of the laser swelling can be controlled very accurately in the second processing strategy (regime 2). This allows lenses to be generated over a broad range of heights for a given size or a given aperture. For example, the height of a zone may range from a few ten nanometers to a few ten micrometers. In this context, the term “height” generally denotes the maximum height of an arched surface, measured perpendicular to the extended imaginary surface in which the zone is situated.

As exemplary evidence for the suitability of this method variant for generating small flat microlenses ML, FIG. 10A shows a height profile of microlenses of a microlens array, as measured by means of a white light interferometer, and FIG. 10B shows a stereomicroscopic recording of a processed region with a multiplicity of microlenses ML on a polymer substrate SUB made of the special polymer MR-7. The absolute water content was less than 1 wt. %, the absorptance in the order of approx. 45%.

In principle, microlenses may also be generated using different patterns, for example, spirals. However, our experience suggests that trajectories characterized by many jumps or discontinuous vector trains should rather be avoided.

In terms of the fundamental choice of laser power and number of traversals, the interplay of which defines the energy introduced, a combination of higher laser power with a reduced number of traversals usually appears more advantageous than processing with a greater number of traversals with a lower laser power.

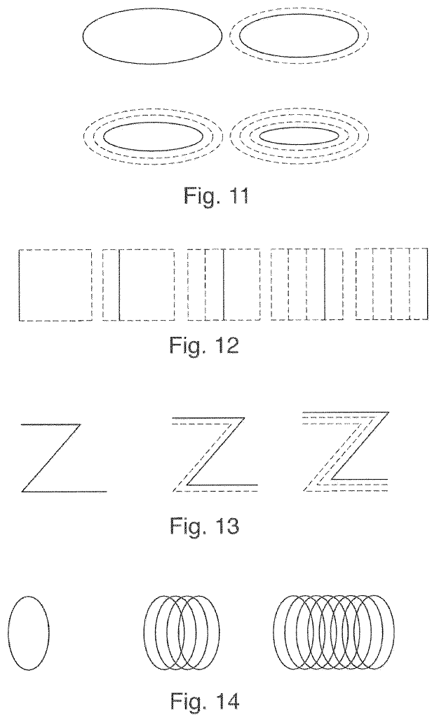

The examples above explain a few fundamental principles of preferred embodiments on the basis of the creation of circular zones. However, the principles may be applied accordingly to generate zones whose basic shape or form deviates significantly from the circular shape. In this respect, FIG. 11 shows a schematic illustration of laser trajectories for generating an elliptical surface structure by irradiation with four concentric elliptical trajectories, from outside in. FIG. 12 shows a schematic illustration of straight-lined laser trajectories for generating a rectangular surface structure by filling the rectangular contour with parallel lines.

In an alternative to the above-described, generally convex closed surface shapes, it is also possible to generate shapes that deviate therefrom. In this respect, FIG. 13 shows, by way of example, a schematic illustration of the laser trajectory for generating an open Z-shaped surface structure or zone that is described by polygons.

By way of example, FIG. 14 shows a schematic illustration of a processing strategy with elliptical laser trajectories, which are arranged next to one another with an offset in a spatial direction. In this way, it is, for example, possible to generate elongate surface structures with a relatively high aspect ratio between length and width, e.g. rod lenses.

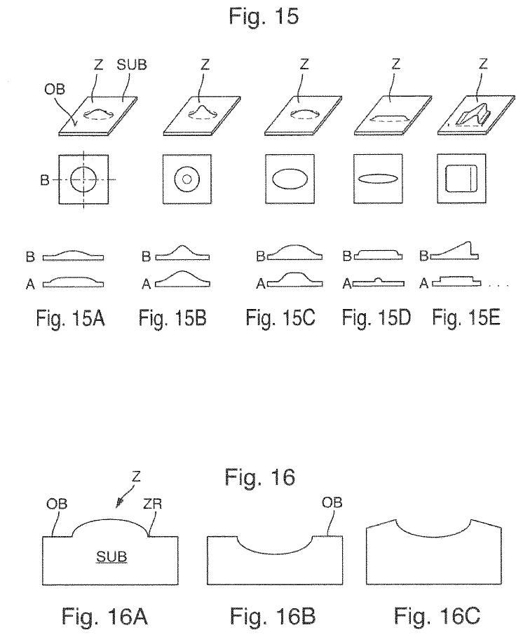

To illustrate the options within the scope of embodiments, FIG. 15 shows a non-comprehensive list of different possible geometries of zones in partial FIGS. 15A to 15E. In this context, the upper partial figure shows an oblique perspective view of a single zone Z on an otherwise plane surface OB of a polymer substrate SUB, the partial figure below shows a plan view of the zone for the purpose of illustrating their basic shape or aperture and the partial figures below this each show perpendicular sections along the directions A and B. FIG. 15A shows the conditions for a circular zone Z with a convexly arched surface; FIG. 15B shows an example of a circular zone with a rotationally symmetric aspherical surface shape; FIG. 15C shows an example of an astigmatic lens with an elliptical aperture; FIG. 15D shows an example of a rod lens, the extent of which in the longitudinal direction (along B) is multiple times greater than its extent in the width direction (direction A); and FIG. 15E shows a zone with a generally rectangular basic shape and a substantially wedge-shaped surface shape, by means of which an optical microelement with the effect of a prism is created.

Even though the effect of the laser swelling is characterized by a surface-near volume increase, concave lenses may also be created with the aid of the method. To this end, it is possible to use at least two different approaches which are illustrated on the basis of FIGS. 16A to 16C. FIG. 16 shows schematic illustrations of different lens types that may be generated with the aid of suitable method variants. FIG. 16A shows a convex structure resulting from greater swelling up of the polymer material of the substrate SUB in the center of the zone Z relative to the zone edge ZR. FIG. 16B shows a concave structure in the region of the zone Z, which was generated by local drying with the aid of laser radiation. Local drying with the aid of a laser beam can be implemented below the softening temperature of the polymer or by way of laser swelling, as described above, albeit with the use of an adapted energy input. While the latter is typically designed for heat accumulation in the center of the overall trajectory when generating convex lens geometries and, accordingly, higher swelling arises in the center than at the edge (FIG. 16A), the regions at the edge may be made to swell up higher than in the center for concave lens shapes, as illustrated on the basis of FIG. 16C. Thus, it may be useful to adapt the transition to adjacent surfaces by laser swelling.

In the production processes performed so far, lens-like or prismatic zones with diameters or apertures in the range from approx. 5 μm to approx. 500 μm were produced. The reliably generable heights were usually in the range from approx. 20 nm to more than 20 μm.

In some embodiments, relatively small zones in the form of flat microlenses were generated systematically, the latter having had a height H and a diameter D, where the condition 1000>V>500 applies to a relationship V=D/H, furthermore where the condition 10 nm<H<100 nm, in particular 15 nm<H<50 nm, and/or the condition 15 μm<D<30 μm preferably applies. For example, the height can be in the range of 30 nm to 40 nm, and the diameter can range from 20 μm to 25 μm. An advantage of such small and flat lenses is that the lenses are no longer visually identifiable (no scattering) but are nevertheless optically effective by generating additional foci as an addition to the basic refractive power of the optics substrate. A useful application lies in the manufacture of plastic spectacle lenses for myopia management with microlens arrays that comprise such small flat lenses.

### Global Temperature Control

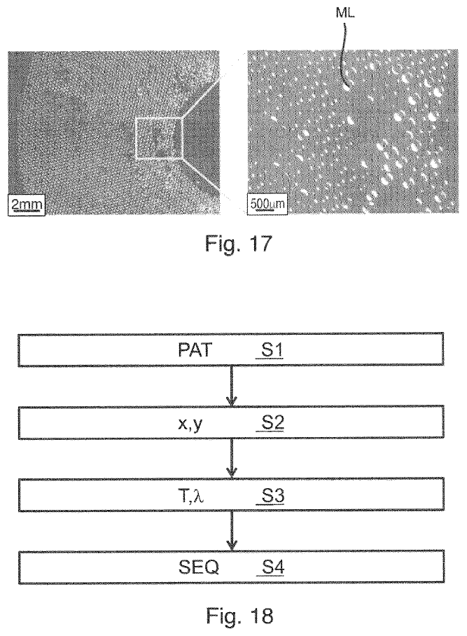

Frequently, the intention is to generate surface structuring in which a large number of similar or disparate zones with special surface shapes are distributed closely together over the surface in accordance with a pattern. We have recognized that specific problems may arise hereby and may be traced back to the very low thermal conductivity of the polymers. For example, the latter is in the order of 0.19 W/m×K for PMMA. On account of the low thermal conductivity, the energy input when generating a microlens or any other structured zone may decisively adversely affect the shape and size of a further microlens that is situated in the immediate neighborhood and processed in quick succession. Since the process window with respect to the energy that is to be introduced and required for swelling is relatively narrow particularly for small and/or flat lenses, the heat management on a macroscopic length scale is also very important according to our insights. For illustrative purposes, FIG. 17, left, shows a light-microscopic image of a microlens array on an MR-7 spectacle lens blank with an insufficient adaptation of the heat distribution. In the magnified detail in FIG. 17, right, it is quite evident that an unequal distribution of microlenses with different apertures and/or heights has arisen instead of the desired microlenses ML of equal size, with some surface regions even being devoid of microstructures.

According to our insights, extended microlens arrays and/or small distances between the lenses require a special and layout-adapted strategy for distributing the thermal load with the goal of not generating any lenses in areas on the substrate that have been preheated too much. The heat input is also relevant in view of the water content in the polymer since the swelling, i.e. the laser-induced increase in volume, could only be observed in the presence of a sufficient amount of water, and drying could in actual fact be determined in the event of insufficient energy input or insufficient temperature.

To counteract this problem, specifically adapting the processing pattern to the required geometry of the lens arrays is often sensible, in particular wherein the physical and thermal properties of the substrate material, the number of lenses, the arrangement of the lenses and the energy and heat input required for the generation of a lens should be taken into account. An expedient variant of defining a processing pattern is explained on the basis of the flowchart in FIG. 18. The processing pattern (pattern, denoted PAT) is defined in a first step S1, especially in view of the number of lenses, the spacing of the lenses, the arrangement of the lenses (e.g. hexagonally or according to a rectangular pattern) and the size of the lenses (and hence the local energy input by way of the laser). This is followed in step S2 by the calculation of the coordinates (denoted x, y) for the respective lenses. On the basis of this, the impressed temperature (denoted T) is estimated in step S3, for example, on the basis of the thermal conductivity (denoted 2) in the material, convection, etc., for the respective coordinates of the individual lenses. On the basis of this, the processing sequence (sequence, denoted SEQ) is defined or optimized in step S4 using temperature and distance criteria and, for example, complemented by the introduction of waiting times or variations in the laser parameters.

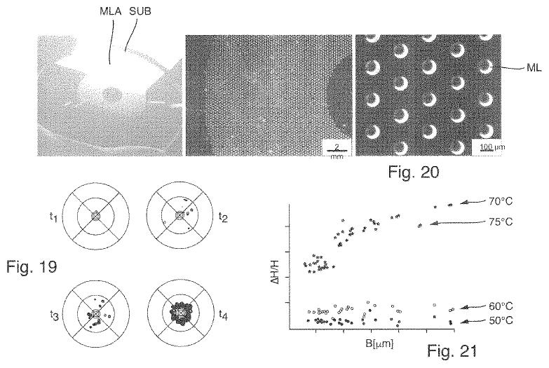

A characteristic of an advantageous processing strategy consists in the generation of a first zone at a first location initially being followed by the generation of a second zone at a relatively large distance before a third zone located closer to the first zone is generated. In this context, numerical simulation by means of the finite element method (FEM) was found to be particularly advantageous in respect of defining the processing strategy. In this respect, FIG. 19 shows, in the four partial figures, the FEM-method-determined temperature distribution in a spectacle lens when generating a microlens array in a peripheral viewing region at arbitrarily selected, temporally successive times t1 to t4. It is evident how zones of elevated local temperature develop gradually at different regions that are located relatively far from one another. The heating of the target region with an increasing number of introduced microlenses is also clearly identifiable. Thus, the fact that a local temperature threshold value of 30° C. must not be exceeded was a stipulation for the simulation. Other target functions, for example, lowest temperature at a greatest distance or lowest temperature at a smallest distance, can also be chosen.

Therefore, after an appropriate optimization of the processing strategy in view of the sequence of the microlenses to be generated, it is also possible to generate extended microlens arrays with a high packing density. In this respect, FIG. 20 shows light-microscopic images of a ring-shaped microlens array MLA on an MR-7 spectacle lens blank with an optimized heat management with increasing magnification. It is evident that the problems regarding irregular lens distribution and size, as explained on the basis of FIG. 17, have been rectified.

For targeted processing, the substrates to be processed are mounted in a suitable substrate holder. Preferably, the latter should be constituted such that no heating back-reflection of the laser radiation transmitted through the workpiece is able to lead to an unwanted, additional and position-dependent energy input into the substrate. In a preferred method, the substrate is only mounted in its periphery, wherein a sufficient distance is maintained from a base located below the workpiece. In addition to that or in an alternative, a beam trap could be integrated under the workpiece.

In addition to the temperature control by the targeted optimization of the energy input by the laser, the heat dissipation can be increased with the aid of complementary technical measures. For example, a gas (e.g. compressed air or an inert gas) may be applied to the workpiece during the processing. For example, the gas flow may be directed substantially coaxially with the laser beam or at an acute angle and/or symmetrically with respect to the laser beam. In our experience, the temperature and the volumetric flow rate of the gas have a decisive influence on the heat transition to the surroundings by convection. An unwanted and undefined input of water can be counteracted by additional drying of the gas.

### Post-Treatment Following the Laser Processing

In some instances, a heat treatment and/or drying may be useful after the laser processing operation. By using, for example, a drying cabinet or oven to store the components or polymer substrates processed by means of laser swelling, the geometry can be adapted further or modified in a targeted manner by withdrawing water after the completion of laser swelling. How pronounced this effect is can be controlled by the storage duration and storage temperature. As regards the latter, the storage temperature should however be significantly below the softening temperature of the polymer or, optionally, of layers located thereon since the swelled-up or dried structures could otherwise relax and/or layer effects might arise at interfaces.

The fact that targeted storage can influence the geometry of the surface shape in controlled fashion is evidenced by the diagram in FIG. 20. FIG. 21 shows the relative change in height ΔH/H of microlenses in an MR-7 plastics substrate as a function of their lateral dimensions or aperture, which is represented on the x-axis by the perimeter of the width B. The y-axis represents the relative change in height ΔH/H. It was found that small relative changes in height can be induced for moderate storage temperatures relative to the softening temperature (85° C.), whereas higher temperatures may lead to a significant relaxation or reduction in height, especially in large microlenses. A further insight from the trials is that the relaxation of the lens geometry leads to a significant reduction in the height of the lenses but not to a significant reduction in their size or aperture.

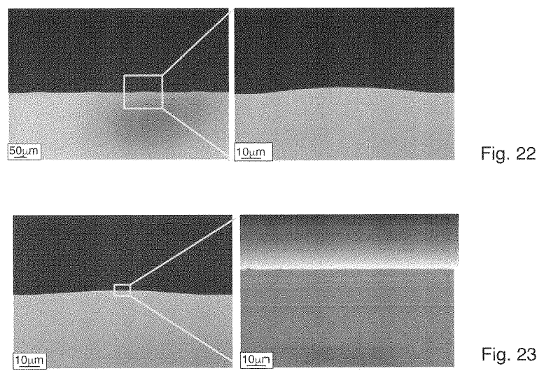

These measurable and controllable effects may be used to perform fine tuning of the surface geometry by heat treatment and/or drying treatment after the laser processing has been completed. Substrates with an uncoated surface can be processed using the method. The method may also be performed on already coated substrates, i.e. through one or more layers situated on the substrate, provided that the optical properties of the coatings in the order of the utilized wavelength are comparable to those of the substrate, and the layer adhesion or the deformability of the layer allows for the form fit during the swelling of the substrate without structural failure. For illustrative purposes, FIG. 22 shows a scanning electron microscope image of the cross section of a microlens array on a multifocal spectacle lens that was generated through a hard lacquer layer. The intactness of the layer construction post laser swelling is clearly visible.

It was also possible to show that the structures generated by the method may also be post-coated using suitable coating methods. To prevent the subsequent coating process from leading to an uncontrollable change in shape, the resultant temperatures in the coating process should be below the temperature at which the structures relax. Such coating methods (especially by means of physical vapor deposition (PVD)) are used routinely in the field of optics.

It was possible to show that athermal post-coating of polymer substrates structured by means of laser swelling does not result in any significant changes to the initially set lens geometry, provided there is a suitable process regime. In this respect, FIG. 23 shows a scanning electron microscope image of the cross section of a microlens array on a multifocal spectacle lens that, by means of a PVD method, was provided with an inorganic multilayer stack through a hard lacquer layer after laser swelling.

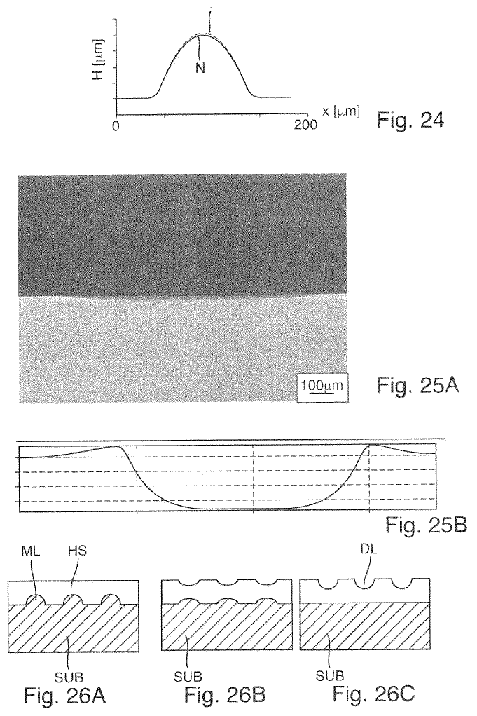

FIG. 24 shows a diagram with a comparison of the lens geometry of a microlens in an MR-7 substrate, measured by means of a white-light interferometer, before (V) and after (N) the deposition of an inorganic layer stack. It is evident that the coating may be generated in such a way that the surface geometry is largely maintained in the zone.

However, it is also possible to bring about a targeted modification to the surface shape by special post-coating methods and, for example, convert initially convex swollen structures into a concave lens structure. In this respect, FIG. 25B shows a cross-sectional profile of a microlens in an MR-7 substrate as detected by means of a white-light interferometer; FIG. 25A shows the scanning electron microscope image of the cross-sectional area.

Moreover, the design of the layer stack and specifically its permeability to water may allow the swelling behavior to be controlled further by the water. Accordingly, water-permeable coatings may promote the postprocessing of microlenses by way of a thermal post-treatment, while impermeable coatings that are largely impermeable to water are able to better conserve the impressed state.

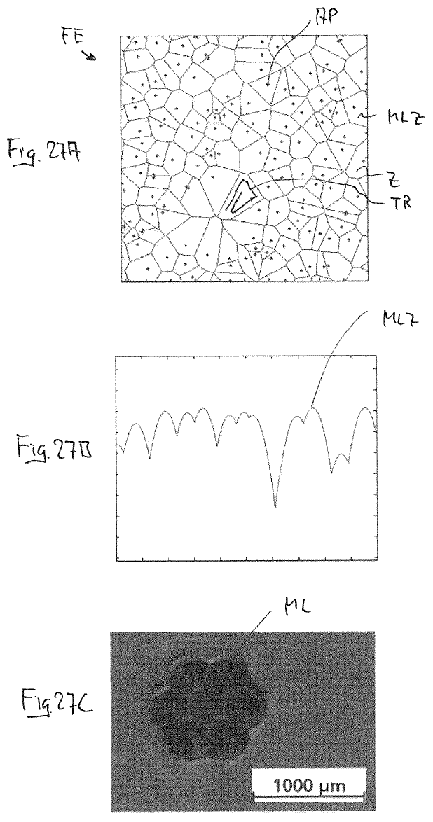

A suitable placement of a coating operation in a process chain for producing an optical functional element allows, inter alia, the generated optical functional elements to be inverted, trimmed or stabilized if required. In this respect, the selection of suitable coating methods and coating process parameters is also important. A few aspects are explained below on the basis of FIGS. 26A to 26C.

As a result of an inversion, originally convex surfaces may be converted into an optically effective concave structure in the region of the zones. In the exemplary situation, the optical functional elements in the form of raised microlenses or zones with a convexly arched surface are initially generated on an uncoated substrate SUB. The substrate is subsequently coated with a hard lacquer layer HS. On account of the surface tension and flow properties of the coating material, the surface of this hard layer is initially smooth prior to curing; the hard layer thickness is locally thinner above the optical functional elements on account of their arching. The viscosity of the hard layer increases during the curing process, while the optical functional elements relax slightly in the exemplary situation. Given the increased viscosity, the surface tension is no longer sufficient to level the surface or pull it straight. Thus, following the complete curing of the hard layer and a partial or complete relaxation of the optical functional elements generated in the substrate, an inverted optical functional element in the form of a “dent” DL of defined depth and curvature arises in the finished product in the region of the originally generated convex microlenses.

To modify the surface shape in a targeted fashion by a certain extent, i.e. to trim a surface shape in a zone, it is possible, for example, to proceed in such a way that the optical functional elements are initially generated by laser processing operations on an uncoated substrate or on a substrate that has been coated with a part of the complete coating system. The height of the optical functional elements can be reduced and/or their shape can be modified by way of a suitable choice of the process parameters (for example, temperature, pressure, moisture) during the subsequent coating steps.

Since the mechanical properties of most functional coatings deviate significantly from those of the polymer-based substrates, subsequent coating processes may stabilize the surface structures provided the layer properties are suitably chosen. It is also possible to generate coating systems that are essentially impermeable to water by choosing suitable deposition methods and other parameters relevant to the coating process (e.g., ion assistance, atomic layer deposition). As a result, moisture-induced aging processes of the substrate material and a relaxation of the generated optical functional elements may be suppressed. Moreover, this allows moisture in the substrate to be captured for the structure generation within the meaning of the method, or dried regions can be protected from the absorption of ambient moisture. Furthermore, the structure generation by way of functional coatings provides the option of using the volume change generated by the method described to induce a mechanical stress in the coating at the interface between coating and substrate and within the substrate. Defects can be generated in the layer system as a result, for example, by delamination. The type and frequency of the defects may correlate with the chosen process parameters of the method and may thus be used to quantify the layer adhesion of the functional coating. Hence, a layer adhesion test is also realizable within the scope of the method.

FIGS. 27A and 27B are used to describe a further advantageous possible use of methods and devices of the type described herein. FIG. 27A shows a schematic plan view of an optical functional element FE with microlenses MLZ which, as a diffuser, is designed to generate an intensity distribution that is as homogeneous as possible in the far field in the event of coherent or partly coherent light radiating therethrough. FIG. 27B shows a schematic cross section through the functional element with randomly distributed microlenses MLZ. The figures are taken from the journal article “From regular periodic micro-lens arrays to randomized continuous phase profiles” by M. Cumme and A. Deparnay in: Adv. Opt. Techn. 2015; 4(1): 47-61 and are intended to illustrate the potential presented in this application.

The functional element FE designed as a microlens array may be produced using a plane parallel plate made of a polymer material containing water as a starting point. In the exemplary situation, the entire e.g. square surface should be filled without gaps using microlenses with different shapes and different refractive powers that have been distributed at random. The lateral distribution of the zones Z which should form the microlenses MLZ is specified using a Voroni tessellation. To this end, a multiplicity of initial positions AP are distributed at random over the area to be structured. The initial positions AP form the future central lens positions. An individual Voroni cell is defined for each of these initial positions, and it covers the region that is closer to this specific initial position AP than any other. This creates an asymmetrically shaped, polygonal zone Z around each initial position. The zones may have three, four, five, six, seven or more corners that are connected by way of straight lateral edges of the zones. Immediately adjacent zones adjoin each other at a common lateral edge such that the area is filled without gaps. Each of the zones Z is then irradiated along trajectories TR using laser radiation in a manner analogous to the above-described exemplary embodiments, until the surface form desired for the respective zone arises due to controlled laser swelling. FIG. 27B shows a possible cross section through the functional element after the irradiation has been completed. In the illustrated example, the randomly distributed microlens elements MLZ have approximately the same radii of curvature but different heights.

Should a coherent plane wave be used as an input source, such a diffuser generates a random speckle intensity distribution in the far field. By comparison, a conventional periodic microlens array generates a regular arrangement of diffraction spots in the far field should the same source be used. Should a partly coherent light source be used, the far-field distribution of a regular microlens array may comprise bothersome periodic inhomogeneities. Should the same partly coherent light source be used, a random microlens array with similar typical lens sizes as a corresponding regular array exhibits a far field with non-periodic inhomogeneities that have a less bothersome effect on illumination applications.

For comparison purposes, FIG. 27C shows an image of a surface of a transparent functional element with a regular, area-filling distribution of similar microlenses ML which substantially have a hexagonal shape. Thus, too, the neighboring zones adjoin each other without gaps.

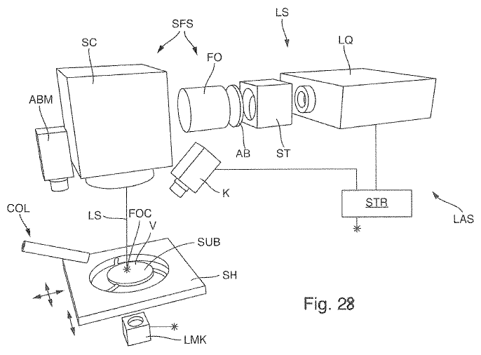

FIG. 28 is used to explain an exemplary embodiment of a device LAS for producing functional elements from polymer substrates in accordance with preferred variants of the method described herein. The device also referred to as a laser processing device comprises a computer-assisted control unit STR for controlling components communicating therewith. The control software resides in a memory of the control unit. A stored database contains experimentally ascertained database entries for a multiplicity of different polymer materials and parameter sets dependent on the polymer, a radiation-traversed thickness of the substrate and the absorption and/or the water content. Characteristic map data that in material-specific fashion represent the functional relationship between the wavelength of the laser radiation and the water content of the polymer and/or a measurable quantity dependent on the water content may be stored for specific polymer materials. The control unit has access to the stored data and may, in the style of a lookup table, derive and set parameter sets for conditions of the laser processing expected to be suitable.

A substrate holder SH serves to receive a respective substrate SUB, on the front surface V of which a microlens array with a multiplicity of small flat lenses should be generated. For example, the substrate could be a spectacle lens made of a special polymer, for example, MR-7.

The device furthermore comprises a laser system controllable by way of the control unit STR and having a laser radiation source LQ for emitting laser radiation at an operating wavelength from the wavelength range between approx. 1.9 μm and 2 μm. In the exemplary situation, provision is made of a thulium fiber laser with an operating wavelength of approx. 1.9 μm. A beam guiding system SFS serves to guide the laser beam and create a laser focus FOC in the region of the front surface V of the substrate. The laser beam is focused; for example, the focal diameter can be located below 15 μm, optionally at approx. 10 μm. Thus, the laser beam passes through a shutter or closure ST, an attenuator AB, beam shaping optics FO and a scanner SC in succession. A distance meter ABM that measures the distance from the substrate front surface is attached to the scanner head.

The substrate holder SH is constituted and arranged such that no heating back-reflection of the laser radiation transmitted through the workpiece is able to lead to an unwanted, additional and position-dependent energy input into the substrate. The substrate holder is arranged at a distance above a surface underneath. For example, the distance can be at least as large as the half diameter or full diameter of the substrate. In addition to that or in an alternative, a beam trap can be integrated under the substrate. Thus, the substrate is only grasped at three points on the outer edge that are offset around the circumference.

A movement system not depicted in any more detail is configured to generate relative movement between the substrate SUB and the laser beam, in such a way that the substrate can be irradiated by the laser beam in accordance with a predefinable processing strategy at different points of a region to be structured. In the process, the substrate may remain stationary or be moved (see the double-headed arrows); the scanner SC is used to displace the focus and guide the latter over the surface along trajectories.

A camera K connected to the control unit STR is part of a camera-based pattern recognition system that operates in reflection.

The laser processing system enables an in-process absorption measurement for determining the partial absorption of the substrate at the operating wavelength before and/or during the laser processing operation. Thus, the absorption measurement is a measurement of the attenuation of the laser beam LS when passing through the substrate SUB. To this end, a power measuring head LMK is installed under the substrate holder. A control loop that is configured to control at least one laser parameter, in particular the laser power, on the basis of a measurement result from the absorption measuring system is constructed by way of the control unit STR of the device. As a result, the laser power can be matched precisely to the absorptance of the irradiated polymer material ascertained by measurement.

Moreover, a cooling apparatus COL for actively cooling the substrate during the laser processing operation is installed for the purpose of stabilizing the processing conditions. Thus, the cooling apparatus is embodied as a contactlessly operating convection cooling unit for applying a cooling gas to the substrate. Said cooling gas is blown onto the processed front side V by way of a nozzle. This ensures a gentle heat dissipation and a precise temperature control within the scope of the heat management. Deviating from the illustration, the gas flow is blown onto the substrate substantially coaxially with the laser beam and/or symmetrically with the latter of other embodiments.

The components of the system may be housed in a housing with a climate-controllable interior, in which there is a stable temperature and a controlled moisture content such that temporally stable processing conditions can be ensured.

1. A method for producing a functional element comprising a substrate substantially consisting of a polymer, at least one surface of said substrate having at least one zone with a surface shape that deviates from a surface shape in a surrounding of the zone, the method comprising:
generating the zone in a laser processing operation by irradiating a surface region of the substrate is irradiated with laser radiation in such a way that a change in volume of the polymer is generated in a surface-near volume region of the substrate by way of an interaction of the laser radiation with the polymer, this volume change leading to a lasting change of the surface shape in the zone,
providing a substrate consisting of a water-containing polymer which at an operating wavelength of the laser processing operation has an absorptance that is selected or set taking into account a functional relationship between the wavelength of the laser radiation, a water content of the polymer and the absorptance.

2. The method as claimed in claim 1, characterized by a controlled modification of the water content of the polymer of an initial substrate to set the absorptance before the start of the laser processing operation, wherein the controlled modification comprises at least one drying operation for reducing the water content and/or at least one loading operation for increasing the water content, preferably wherein the controlled modification of the water content comprises a combination of at least one drying operation and at least one loading operation performed before or after the drying operation, wherein, in particular during a drying operation, the substrate is dried to below the softening temperature of the polymer in an oven, preferably in vacuo or under negative pressure, and the dried substance is subsequently exposed to water or a moist ambient atmosphere over a defined period of time within a loading operation, wherein a relative reduction in weight or a relative increase in weight is preferably measured in the process.

3. The method as claimed in claim 1, characterized by an experimental determination of the functional relationship between the wavelength of the laser radiation and the water content of the polymer and/or a measurable quantity dependent on the water content by way of a multiplicity of trials for ascertaining a characteristic map, by preference wherein process parameters of the laser processing operation are set on the basis of data from the characteristic map.

4. (canceled)

5. The method as claimed in claim 3, characterized by the creation of a database with database entries for parameter sets dependent on the polymer, a radiation-traversed thickness of the substrate and the absorption and/or water content.

6. The method as claimed in claim 1, characterized in that the functional element is designed as an optical functional element and a single zone or multiple zones is/are formed as optically effective lenses and/or prisms, by preference wherein the polymer is transparent in the visible spectral range and the laser radiation has an operating wavelength from the wavelength range between 1.1 μm and 9.2 μm.

7. The method as claimed in claim 1, characterized in that generating a zone involves using a focused laser beam that, in the region of the zone, has a focal region with a diameter that is substantially smaller than a diameter of the zone to be generated, and in that the focal region is guided over the zone along at least one trajectory that corresponds to a processing pattern so that different locations in the zone are exposed to laser radiation successively in time, wherein some or all locations in a zone to be exposed to laser radiation are traversed multiple times, in particular two times, three times, four times or more frequently, wherein each traversal involves the introduction of only a fraction of the laser energy to be introduced overall, by preference wherein an individual, multiple or all trajectories are traversed multiple times.

8. (canceled)

9. The method as claimed in claim 1, characterized in that to generate a zone, the focused laser beam is guided over the zone along two or more closed encircling trajectories, in particular concentric circular trajectories of different diameters, by preference wherein in at least one of the trajectories, preferably in all of the trajectories, the laser beam is guided over a circular trajectory for a predeterminable number of multiple traversals, wherein by preference starting points of trajectories of different sizes are offset from one another in the circumferential direction, when providing irradiation along closed encircling trajectories, in particular circular trajectories.

10. The method as claimed in claim 1, characterized in that a first trajectory, in particular a first circular trajectory, is irradiated with an envisaged total number of traversals, and subsequently at least one second trajectory with a different size is irradiated with an envisaged total number of traversals.

11. The method as claimed in claim 1, characterized in that in a first run, each of the trajectories of different sizes is irradiated with a number of traversals that is lower than the predetermined total number of traversals for the respective trajectory, and in that this is followed by two or more further runs, in which some or all trajectories of different sizes are irradiated with a number of traversals that is lower than the predetermined total number of traversals for the respective trajectory, until each of the trajectories has been irradiated with the envisaged total number of traversals, by preference wherein each of the trajectories to be irradiated is traversed only once in each run.

12. The method as claimed in claim 1, characterized in that zones that have a convexly arched surface shape in a portion of the zone or over the entire zone are generated, wherein the surface is preferably curved spherically or aspherically with rotational symmetry.

13. The method as claimed in claim 1, characterized in that zones that have a concavely arched surface shape in the entire zone or in a circular partial zone are created.

14. The method as claimed in claim 13, characterized in that the generation of a concavely arched surface shape involves irradiation by the laser radiation such that locally restricted drying of the polymer below the softening temperature of the polymer is induced, and this leads to a reduction in the specific volume of the polymer while forming the concavely arched surface shape, and/or in that the generation of a concavely arched surface shape in a partial zone of a zone involves irradiating the zone with laser radiation in such a way that an increase in the specific volume in a radially outer annular region is greater than in a partial zone surrounded by the annular region.

15. The method as claimed in claim 1, characterized in that multiple similar or dissimilar zones are generated in a region of the surface to be structured, said zones being distributed over the surface at different locations in the region to be structured, in accordance with a predeterminable pattern.

16. The method as claimed in claim 15, characterized in that the zones are generated successively in accordance with a heat-input-optimized processing strategy, by preference wherein the generation of a first zone at a first location is followed by the generation of a distant second zone before a zone closest to the first zone is generated, wherein by preference a processing sequence of the zones is defined using temperature criteria, distance criteria and zone size criteria to ascertain the processing strategy, wherein by preference a finite element simulation is carried out to ascertain the processing strategy.

17. (canceled)

18. The method as claimed in claim 1, characterized by a controlled heat treatment and/or drying treatment of the functional element after the laser processing operation has been finished, to stabilize the structures generated by the laser processing prior to an intended use at ambient temperature.

19. The method as claimed in claim 1, characterized in that the surface to be structured is coated with a functional coating before the laser processing operation, between selected steps of the laser processing operation and/or after the laser processing operation has been completed, by preference wherein a type of coating and/or the coating process are matched to the water content and/or a water absorption capacity and/or a water release capacity and/or a structural relaxation capacity of the polymer, in such a way that the coating makes a contribution to the shaping and/or the stabilization of the surface shape in the region of the zone.

20. The method as claimed in claim 1, characterized in that the laser processing operation is carried out in such a way that the surface shape generated thereby does not correspond to the desired target surface shape and has a defined shape deviation from the latter, wherein the application of the coating brings about such a change in shape that the desired target surface shape is set.

21. The method as claimed in claim 1, characterized in that relatively small zones in the form of flat microlenses are generated, the microlenses having a height H and a diameter D, where the condition 1000>V>500 applies for a relationship V=D/H, furthermore where the condition 10 nm<H<100 nm, in particular 15 nm<H<50 nm, and/or the condition 15 μm<D<30 μm preferably applies.

22. The method as claimed in claim 1 characterized in that a position distribution of the zones with individually predetermined positions for each of the zones is predetermined for the purpose of generating an array with a multiplicity of similar or dissimilar zones, and the zones are generated successively in a laser processing operation at the predetermined positions with a positioning accuracy specific to the laser processing operation, by preference wherein positions of the position distribution in one or more regions of the surface deviate from closest positions of a two-dimensionally periodic position distribution by a lateral offset that is greater than the positioning accuracy and less than a periodic distance from the closest position of the periodic position distribution, by preference wherein one or more or all zones have a circular form, an elliptical form, a polygonal form, in particular a rectangular form, or a rod-shaped form with an aspect ratio of more than 2 between length and width.

23-28.(canceled)

29. A functional element having a substrate (SUB) substantially consisting of a polymer that is transparent in the visible spectral range, in particular an optics element in the form of a spectacle lens, a contact lens or an intraocular lens, wherein at least one optical surface (OB) of the substrate has a region with at least one zone (Z) that has a surface shape which deviates from a surface shape in a surrounding of the zone (Z), characterized in that the functional element is obtainable or is obtained by a method as claimed in claim 1.

30-32. (canceled)
